(19) United States
(12) Patent Application Publication
(10) Pub. No.: US 2006/0239314 A1
(43) Pub. Date: Oct. 26, 2006

(54) Electro-optic transducer die mounted directly upon a temperature sensing device

(76) Inventor: Lucy G. Hosking, Santa Cruz, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/110,237

(22) Filed: Apr. 20, 2005

(51) Int. Cl. H01S 3/04

(52) U.S. Cl. 372/34; 372/36

(57) ABSTRACT

An optical transmitter having an electro-optic transducer mounted directly on a temperature sensor. Due to the close proximity of the electro-optic transducer and the temperature sensor, the temperature sensor more accurately measures the temperature of the electro-optic transducer. This permits for more refined control of the frequency characteristics of optical light emitted by the electro-optic transducer since the emitted optical frequencies of most electro-optic transducers are heavily temperature dependent.

### BACKGROUND OF THE RELATED ART

1. The Field of the Invention

The present invention relates generally to optical transmitters. More specifically, the present invention relates to optical transmit assemblies in which an electro-optic transducer die is mounted directly upon a temperature sensing device.

2. Background and Related Art

Computing and networking technology have transformed our world. As the amount of information communicated over networks has increased, high speed transmission has become ever more critical. Many high speed data transmission networks rely on optical transceivers and similar devices for facilitating transmission and reception of digital data embodied in the form of optical signals over optical fibers. Optical networks are thus found in a wide variety of high speed applications ranging from as modest as a small Local Area Network (LAN) to as grandiose as the backbone of the Internet.

Typically, data transmission in such networks is implemented by way of an optical transmitter (also referred to as an electro-optic transducer), such as a laser or Light Emitting Diode (LED). The electro-optic transducer emits light when current is passed through it, the intensity of the emitted light being a function of the current magnitude being passed through the electro-optic transducer. Information is conveyed optically by transmitting different optical intensities.

The electro-optic transducer has strong temperature dependencies that can seriously affect performance, depending on the application. For example, in Dense Wavelength Division Multiplexed (DWDM) laser applications, different optical channels are transmitted simultaneously, each optical channel having a tight frequency range that the corresponding optical signal should stay within. Any variance outside of the frequency range could cause inter-signal interference, seriously increasing the error rate of the transmission. Thus, in DWDM laser applications, it is critical that the laser's transmitted frequency be tightly controlled. Nevertheless, the frequency characteristics of a laser are heavily temperature-dependent. More specifically, the frequency characteristics of the optical emissions from the PN junction of the laser are heavily dependent on temperature. Thus, in DWDM laser applications, there is tight control of the temperature of the electro-optic transducer. Although DWDM has been discussed here, there are a wide variety of applications in which it may be desirable to accurately control the temperature of the emitting PN junction of the electro-optic transducer.

The temperature control of the electro-optic transducer typically relies on a temperature feedback system. Specifically, a temperature sensor is provided in proximity to the electro-optic transducer. Depending on the sensed temperature, a temperature driver then heats or cools the temperature sensor as appropriate until the temperature sensor detects a temperature within an acceptable temperature range. The aim here is that by tightly controlling the temperature of the temperature sensor, the temperature of the proximate electro-optic transducer will also be tightly controlled.

However, the temperature sensor and the electro-optic transducer cannot occupy the same space at the same time. Therefore, the temperature sensor, though relatively proximate to the electro-optic transducer, is still placed some finite distance from the electro-optic transducer. There will thus be some finite amount of thermal resistance between the temperature sensor and the electro-optic transducer.

The temperature of the electro-optic transducer may vary significantly as the electro-optic transducer itself generates heat. Furthermore, the temperature sensor may also generate heat when dissipating power. In addition, the temperature sensor and the electro-optic transducer may dynamically exchange heat with other surrounding components and the environment. Thus, due to the thermal resistance between the temperature sensor and the electro-optic transducer, there will be some error between the temperature sensed by the temperature sensor and the actual temperature of the electro-optic transducer. In this way, even very tight control of the temperature of the temperature sensor will not necessarily result in tight control of the temperature of the electro-optic transducer.

Accordingly, what would be advantageous are mechanisms in which there is tighter control of the temperature of the electro-optic transducer.

### BRIEF SUMMARY OF THE INVENTION

The foregoing problems with the prior state of the art are overcome by the principles of the present invention, which relate to an optical transmitter that includes a temperature sensor and an electro-optic transducer mounted directly on the temperature sensor. Due to the extremely close proximity of the electro-optic transducer and temperature sensor, the thermal resistance between the electro-optic transducer and the temperature sensor is reduced. Accordingly, the temperature detected by the temperature sensor more closely tracks the actual temperature of the electro-optic transducer.

The highly accurate temperature measurements allow for tight temperature control of the electro-optic transducer thereby more tightly controlling the frequency of the optical emissions from the electro-optic transducer. The tight control of frequency, in turn, reduces the risk of inter-signal interference in DWDM applications, and may even permit the frequency span of a given optical channel in a frequency division multiplexed environment to be even further reduced in future DWDM standards, thereby potentially increasing the possible optical data rate.

Additional features and advantages of the invention will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawing. Understanding that this drawing depicts only an example embodiment of the invention and is not therefore to be considered to be limiting of its scope, the invention will be described and explained with additional specificity and detail through the use of the accompanying drawing in which:

FIG. 1 illustrates an optical transmit assembly in accordance with a general embodiment of the present invention in which an electro-optic transducer is mounted directly upon a temperature sensor.

### DETAILED DESCRIPTION OF THE PREFERRED EMBODIMENTS

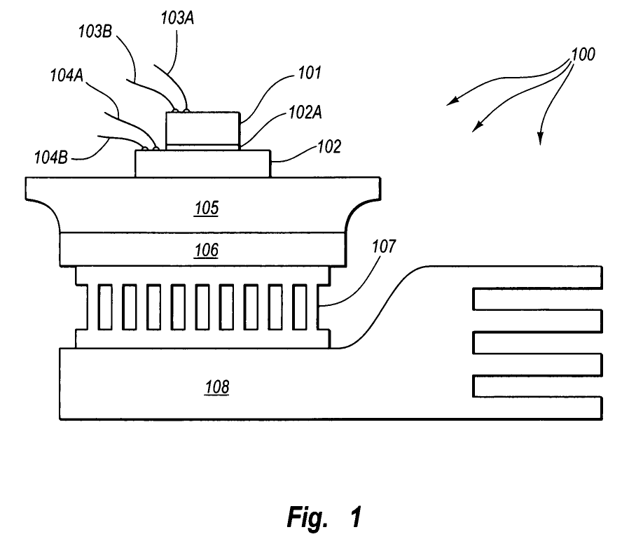

FIG. 1 illustrates an embodiment 100 of an optical transmit assembly in which the principles of the present invention may be employed. While the optical transmit assembly will be described in some detail, the optical transmit assembly is described by way of illustration only, and not by way of restricting the scope of the invention.

The optical transmit assembly 100 includes an electro-optic transducer 101 mounted directly on a temperature sensor 102. The electro-optic transducer 101 may include any electro-optic transducer including a laser or a light-emitting diode. If a laser, there is no restriction on the type of laser. Examples of lasers include edge-emitting lasers, Vertical Cavity Surface Emitting Lasers (VCSELs), and others. The temperature sensor 102 is used to measure the temperature of the electro-optic transducer 101. Since the temperature sensor 102 is so closely positioned to the electro-optic transducer 101, the thermal resistance between the temperature sensor 102 and the electro-optic transducer 101 is reduced. Accordingly, the more closely-positioned temperature sensor 102 more accurately measures the temperature of the actual electro-optic transducer 101. Thus, the temperature (and frequency characteristics of the electro-optic transducer) may be more finely controlled. In order to further improve the accuracy the temperature sensor, the electro-optic transducer 101 may be mounted on a thermal sensing side 102A of the temperature sensor 101.

The temperature sensor 102 may be any temperature sensor such as, for example, thin film thermocouples, Resistance Temperature Detectors (RTDs), silicon diode temperature sensors, integrated circuit temperature sensors, or any the temperature sensor. It is advantageous, however, for the mechanism bond between the electro-optic transducer 101 and the temperature sensor 102 to be strong. Accordingly, a temperature sensor 102 that is generally flat is rather suitable for the principles of the present invention if the electro-optic transducer is also flat. The electro-optic transducer 101 may be mounted to the temperature sensor 102 using conventionally available high thermal conductivity bonding material such as, for example, epoxy glue. Alternatively or in addition, the optical transducer 101 may be soldered to the temperature sensor 102.

Electrical connections 103A and 103B (e.g., bond wires) are shown connected to the electro-optic transducer 101, and provide an electrical signal to the electro-optic transducer. In addition, electrical connections 104A and 104B are shown connected to the temperature sensor 102, and may also provide a current or other signal to the temperature sensor 102. Depending on the type of electro-optic transducer 101 and temperature sensor 102, fewer or greater numbers of electrical connections may be used.

The temperature sensor 102 may be mounted on a substrate 105 thereby providing structural support for the temperature sensor 102 and electro-optic transducer 101. A thermo-electric cooler 107 is thermally coupled to the substrate 105. In order to allow uniform heat transfer with the lower surface of the substrate 105, a thermally conductive piece 106 may be positioned between the thermo-electric cooler 107 and the substrate 105. A heat sink 108 is thermally coupled to the thermoelectric cooler 107.

Accordingly, the principles of the present invention provide an optical transmit assembly in which the electro-optic transducer temperature (and thus the emitted frequency) may be tightly controlled. This is particularly important in DWDM applications since tight control of frequency prevents inter-signal interference. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

What is claimed and desired secured by United States Letters Patent is:

1. An optical transmit assembly comprising:
a temperature sensor; and
an electro-optic transducer mounted directly on the temperature sensor.

2. An optical transmit assembly in accordance with claim 1, wherein the temperature sensor has a thermal sensing side, and the electro-optic transducer is mounted directly on the thermal sensing side of the temperature sensor.

3. An optical transmit assembly in accordance with claim 1, wherein the electro-optic transducer is a laser.

4. An optical transmit assembly in accordance with claim 1, wherein the electro-optic transducer is a Light Emitting Diode (LED).
